(19) United States
(12) Patent Application Publication
(10) Pub. No.: US 2006/0188433 A1
(43) Pub. Date: Aug. 24, 2006

(54) Metal-oxide based process for the generation of hydrogen from water splitting utilizing a high temperature solar aerosol flow reactor

(76) Inventors: Alan W. Weimer, Niwot, CO (US); Christopher Perkins, Boulder, CO (US); Allan A. Lewandowski, Evergreen, CO (US); Carl Bingham, Lakewood, CO (US)

Correspondence Address: GREENLEE WINNER AND SULLIVAN P C, 4875 PEARL EAST CIRCLE, SUITE 200, BOULDER, CO, 80301, US

(21) Appl. No.: 11/282,116

(22) Filed: Nov. 17, 2005

Related U.S. Application Data
(63) Continuation-in-part of application No. 10/383,875, filed on Mar. 7, 2003, now Pat. No. 7,033,570.
Application No. 10/383,875 is a continuation-in-part of application No. 10/239,706, filed on Feb. 24, 2003, now Pat. No. 6,872,378.
(60) Provisional application No. 60/628,641, filed on Nov. 17, 2004.
(60) Provisional application No. 60/362,563, filed on Mar. 7, 2002.
(60) Provisional application No. 60/203,186, filed on May 8, 2000.

(51) Int. Cl. C01G 9/02

(52) U.S. Cl. 423/622; 423/605

(57) ABSTRACT

The invention provides methods for reduction of metal oxide particles using a high temperature solar aerosol reactor. The invention also provides metal-oxide based processes for the generation of hydrogen from water splitting using a high temperature solar aerosol reactor. In addition, the invention provides solar thermal reactor systems suitable for use with these processes.

### CROSS-REFERENCE TO RELATED APPLICATIONS

This application claims the benefit of U.S. Provisional Application No. 60/628,641, filed Nov. 17, 2004, and is a continuation-in-part of U.S. application Ser. No. 10/383,875, filed Mar. 7, 2003, which claims the benefit of U.S. Provisional Application No. 60/362,563, filed Mar. 7, 2002, and is a continuation-in-part of U.S. application Ser. No. 10/239,706, filed Feb. 24, 2003, which is the national stage of PCT Application Number PCT/US01/15160, filed May 8, 2001, which claims the benefit of U.S. Provisional Application No. 60/203,186, filed May 8, 2000, all of which are hereby incorporated by reference to the extent not inconsistent with the disclosure herein.

### ACKNOWLEDGEMENT OF GOVERNMENT SUPPORT

This invention was made, at least in part, with support from the Department of Energy under grant numbers DE-FG36-03G013062 and DE-FC36-99G010454. The United States government may have certain rights in this invention.

### BACKGROUND OF THE INVENTION

This invention is in the field of hydrogen gas production, in particular, methods and apparatus for production of hydrogen gas using a solar-thermal reactor.

Interest in hydrogen as a clean fuel has surged in the recent past as concerns over the costs of fossil fuels to the economy, environment, and national security have become paramount. As hydrogen burns only to produce water and can be used in efficient fuel cells, it has a great opportunity to be the replacement for carbon-based fuels in the twenty-first century. The anticipation of this transition has been so great that the future vision for hydrogen power has been labeled the “hydrogen economy.” With this in mind, a number of issues must be taken into account.

The first and foremost of these is that hydrogen in and of itself is simply an energy carrier. Quantities of hydrogen gas on earth are limited, so it must be chemically derived from some other source. Eighty-six percent of the industrial hydrogen produced today is from the steam reforming of hydrocarbons in the production of syngas [1]. Clearly, choosing this route for the hydrogen economy does not release the world from fossil fuel dependence. In the future, it is desired that hydrogen be produced from a clean, renewable chemical source with a clean, sustainable energy source [1].

Hydrogen can be obtained by the splitting of water. The net reaction
H₂O→H₂+½O₂ (Equation 1)
produces only hydrogen and oxygen. When these are recombined for the production of energy (e.g., electricity from a fuel cell), the only product is water, and so the cycle is inherently renewable and pollution-free. The use of heat from concentrated solar energy, a sustainable and clean energy source, can provide the energy required for this endothermic reaction to proceed.

A number of cycles for the splitting of water have been proposed, including ultra-high-temperature direct thermal splitting of water, high-temperature two-step metal oxide oxidation-reduction reactions to split water, and moderate temperature three-step water splitting cycles. Direct thermal splitting of water preferably employs temperatures of at least about 2500 K [34]. Direct thermal splitting of water also requires separation of high temperature oxygen and hydrogen from each other.

Multi-step cycles for hydrogen production from water dissociation can allow use of lower reaction temperatures. Multi-step cycles, which remove hydrogen and oxygen gas in separate steps, eliminate the need to perform high-temperature gas separation of these elements. These advantages come at a price, though. First and foremost is that as the number of process steps increases, the maximum theoretical process efficiency decreases due to the entropic irreversibility of each stage and of the material and energy transfer between stages. With decreased efficiency comes poorer theoretical economics, overall conversion concerns, and bottom line reductions in overall energy production. In addition to decreased efficiency, multi-stage processes require the separation of reaction products at moderate temperatures, transportation of products/reagents between reaction stages, and, for high-temperature reactions, the problem of recombination of dissociated compounds as products are cooled [10, 12, 13].

A final disadvantage of multi-step water splitting cycles is that they involve chemical reactants other than water. For these processes to be entirely sustainable and renewable, not to mention economically viable, these other reagents must be completely regenerated and recycled within the reaction cycle. Otherwise, the process would require a net input of process materials other than water, many requiring more energy to produce than the product hydrogen would eventually yield. All of these disadvantages must be minimized for these multi-stage processes to have a practical advantage over their single-stage water splitting counterpart.

One major class of two-step water splitting cycles where previous research has been concentrated is that of metal-oxide oxidation/reduction steps. The general cycle consists of two steps:
Metal Oxide Dissociation: MₓO_{y}→MₓO_{y-1}+½O₂; (Equation 2)
Water reduction: MₓO_{y-1}+H₂O→H₂+MₓO_{y}: (Equation 3)
The net reaction is the splitting of one mole of water into one-half mole of O₂ and one mole of H₂.

A number of these reaction cycles have been examined in the literature. The ΔG_{f} for some of these cycles has been generated as a function of T, and can be seen in FIG. 1. As can be seen, most of the metal-oxide cycles have negative ΔG_{f} values (corresponding to equilibrium constants greater than one) for reaction temperatures greater than 2500 K. As can be recalled, at this temperature direct water thermolysis is possible, and many of the problems associated with that cycle were directly related to its high temperature. In addition, even though the metal/metal-oxide pairs Mn₃O₄/MnO and Co₃O₄/CoO have low-enough ΔG_{f} for the dissociation reaction to proceed, their yields in the water splitting step of the process are low [10]. Steinfeld et al. [10] suggest that the only feasible two-cycle metal-oxide pairs are ZnO/Zn and Fe₃O₄/FeO.

Metal-oxide cycles are relatively new in consideration, mainly as previous thermochemical water dissociation research focused on cycles that would operate below 1573 K. This is due to the fact that until the recent past, the main source of thermal energy considered for use in the dissociation reaction was nuclear waste heat, and 1573 K was considered to be the maximum safe operating temperature of such a nuclear reactor. With the advent of high-power solar collector systems, much higher temperatures have become possible, with some estimates as high as 3000 K [14].

The metal-oxide cycle that has been most researched in the technical literature is the ZnO/Zn cycle. As can be seen from FIG. 1, it has a ΔG_{f} of zero at 2255 K, making it feasible for modern solar reactor systems [11]. If the Zn is fully recovered in the decomposition step, and ZnO fully recovered in the water splitting step, it is possible to make the only reaction input H₂O and the only products O₂ and H₂, thus completing a renewable, sustainable cycle.

Steinfeld [11] has shown that the Zn/ZnO cycle water splitting reaction has a reasonable rate at temperatures greater than 700 K, and as it is exothermic, it is possible to run this process autothermally. In addition, if the water splitting reaction is run in-line with the decomposition reaction, the inlet preheating of the steam and Zn can come from the solar reactor waste heat [15].

Steinfeld et al. [11] have run an energy analysis on the ZnO/Zn process, calculating the process efficiency for heliostat solar concentrations of 5000 and 10,000 suns. The authors assumed equilibrium conditions and focused on the greatest sources of irreversibility: reradiation losses in the solar reactor and the inherent irreversibility of the Zn—O₂ quench. From this analysis, maximum overall efficiencies (in terms of usable energy) of 36% and 25% were obtained for solar concentrations of 10,000 and 5000 suns, respectively [11, 12].

Keuneke et al. [33] describe solar thermal decomposition experiments in a solar reactor in which concentrated solar energy passed through a window and illuminated a sintered pellet of zinc oxide. An inert gas was introduced into the reactor, flowed past the window and the pellet, and transported the decomposition products to a water cooled condenser coil located inside the reactor's chimney. The zinc yield was reported to depend on the preheat temperature of the inert gas. A zinc yield (moles of Zn(s)/moles of ZnO(s) decomposed) of approximately 0.15 was reported for an inert gas temperature of approximately 1100 K at the reactor entrance and a molar ratio of inert gas to ZnO(s) decomposed of between 1300 and 1400.

Three step metal oxide cycles have also been proposed. If a cycle has three steps, its maximum theoretical efficiency will be less than that of a two-step cycle. However, three-step cycles may be more easily achieved than some two-step cycles.

An example of a three-step metal oxide cycle is the Mn₂O₃/MnO cycle. Specifically, this cycle is
MnO+NaOH→½H₂+NaMnO₂; (Equation 4)
NaMnO₂+½H₂O→½Mn₂O₃+NaOH; (Equation 5)
½Mn₂O₃→MnO+¼O₂ (Equation 6)

This cycle is better than the comparative Mn₃O₄ cycle, as it has a higher yield of H₂ per unit mass of oxide. Sturzenegger and Nuesch [23] calculated efficiencies of 26-51% when ignoring separation steps, and those of 16-21% when taking all steps, including separation, into consideration.

### SUMMARY OF THE INVENTION

The present invention provides processes and apparatus for thermal reduction of metal oxide particles in a high temperature aerosol flow reactor heated using concentrated sunlight. The reduction products are oxygen and a reduced metal oxide product which can be a metal, a metal oxide of a lower valence state, or combinations thereof. In an embodiment, the reduction process can be run at moderate residence times.

The present invention also provides processes for the production of hydrogen from the splitting of water. One step in the processes is the thermal reduction of metal oxide particles in a high temperature aerosol flow reactor heated using concentrated sunlight. The products of the metal oxide reduction reaction can then be used to split water in a series of succeeding steps. The net effect of these reactions is the splitting of water, generating hydrogen and oxygen gases in separate steps. The process for hydrogen generation using concentrated solar energy to reduce a metal oxide may be a two step process or a three step process; each of these steps represents a chemical reaction unit operation.

In the methods of the invention, the metal oxide particles are entrained in a gas stream and fed into a solar-thermal aerosol flow reactor. The gas stream exiting the reactor may entrain solid and/or liquid reduced metal oxide product and/or may comprise gaseous reduced metal oxide product. The gas stream exiting the reactor may also entrain unreacted metal oxide particles. In an embodiment, the gas stream exiting the reactor is then fed to a cooling device. The yield of reduced metal oxide product will be affected by recombination of oxygen with the reduced metal oxide product in the reactor and in the optional cooling device.

In an embodiment, the solar-thermal reactor is a fluid-wall reactor in which the reaction shell has a porous section. In an embodiment, the porous section is located at the downstream end of the reaction shell or tube. When the fluid-wall reactor is operated, a fluid-wall gas flows radially inward into the reaction shell through the porous section of the reaction shell and provides a fluid-wall on the inside of the reaction shell. The fluid wall can prevent oxidation of graphite reactor materials with the product oxygen from the metal oxide reduction. Without wishing to be bound by any particular theory, it is also believed that the fluid wall can limit heterogeneous nucleation of oxide particles on the reaction shell wall, thereby reducing recombination of oxygen with the reduced metal oxide product and increasing the yield of the reduction reaction.

In another embodiment, the solar-thermal reactor is connected to a cooling device having a chamber whose walls which are at least partially porous. When the cooling device is operated, a fluid-wall gas flows radially into the chamber through the porous section of the chamber walls and provides a fluid-wall on the inside of the chamber. The fluid wall in the cooling device can also limit nucleation of oxide particles on the chamber walls.

It has been shown that solar thermal reactors can achieve temperatures between approximately 1500 and 2500 K. Temperatures even higher than this are achievable, but in those regimes materials and reradiation loss issues become major concerns. In an embodiment, the solar-thermal process to split water is operated at temperatures less than 2500 K.

### BRIEF DESCRIPTION OF THE DRAWINGS

FIG. 1 shows the Gibbs energy change of reaction for several decomposition reactions.

FIG. 2 is a schematic cross-sectional view of the central portion of a solar-thermally heated fluid-wall reactor having three walls. The innermost wall of the reactor is a porous “reaction” wall, the next outermost wall of the reactor is a solid “heating” wall, and the outermost wall of the reactor is a transparent “protection wall”.

FIG. 3 is an overall cross-section of another solar-thermal fluid wall reactor.

FIG. 4 is a cross-section of a solar-thermal fluid wall reactor having a transparent window in the protection shell and a heat transfer fluid flowing in a jacket surrounding the protection shell.

FIG. 5 is a schematic of a cross-sectional view of a fluid-wall solar-thermal reactor connected to a cooling device having an expanded cooling chamber.

FIG. 6 is a schematic of a cross-sectional view of a solar-thermal reactor connected to a cooling device having a fluid wall.

FIG. 7 shows a schematic of a zinc oxide cycle for the thermochemical dissociation of water using concentrated solar energy in which reagents other than water are regenerated and recycled within the reaction cycle. Concentrated solar energy is used to decompose ZnO to zinc and oxygen.

FIG. 8 shows a schematic of a Mn₂O₃/MnO cycle for the thermochemical dissociation of water using concentrated solar energy in which reagents other than water are regenerated and recycled within the reaction cycle.

FIG. 9 shows the temperature dependence of equilibrium composition for decomposition of ZnO at 1 atm, 1 mol Ar inerts in feed.

FIG. 10 shows the temperature of complete equilibrium ZnO decomposition in the presence of Ar (P=0.1 MPa).

FIG. 11 shows the temperature dependence of equilibrium composition for decomposition of Mn₂O₃ at 1 atm, 1 mol Ar inerts in feed.

### DETAILED DESCRIPTION OF THE INVENTION

The present invention provides methods and apparatus for thermal reduction of metal oxide particles in a high temperature aerosol flow reactor heated using concentrated sunlight. In an aerosol flow reactor or an aerosol transport reactor, solid or liquid particles are transported into and/or through the reactor via entrainment in a gas stream. In the methods of the invention, the metal oxide particles flow in dilute phase in an entrainment gas and are heated through indirect solar thermal heating to a temperature at which they undergo a reduction reaction. In the methods of the invention, radiation heat transfer to the metal oxide particles can occur at extremely high rates. As used herein, “indirect” heating means that the heating is by radiation from a heated wall that is itself heated indirectly or directly by solar radiation.

Metal oxides suitable for use with invention are compounds consisting essentially one or more metals and oxygen, the compounds being solid at room temperature. In an embodiment, the impurity level is less than or equal to 1%. Metal oxides suitable for use with the invention include mixed metal oxides which include more than one metal, such as mixed metal ferrites. As used herein, mixed metal ferrites are compounds of iron oxide with oxides of other transition metals. For example, included would be iron oxides with Ni(II), Co(II), or Mn(II) inclusions, such as MnFeₓ0₄, NiFeₓ0₄, Ni_{0.5}Mn_{0.5}Fe₂O₄ and Co_{0.5}Mn_{0.5}Fe₂O₄. High temperature dissociation of such oxides can produce an activated, oxygen deficient form, such as Ni_{0.5}Mn_{0.5}Fe₂O_{(4-delta)}. This activated form could be combined with water at relatively low temperatures to yield hydrogen and the original mixed metal oxide. Ferrites useful in the present invention have decomposition temperatures substantially iron oxide.

The reduction reaction produces oxygen and a reduced metal oxide product. The reduced metal oxide product is selected from the group consisting of a metal, a metal oxide and combinations thereof. These combinations can include combinations of metal oxides. For example, Mn₂O₃ may reduce partially to Mn₃O₄ and partially to MnO. Depending on the temperature distribution within the reactor, the reduced metal oxide product may be present in the reactor in gaseous, liquid, or solid forms, or in combinations thereof.

In an embodiment, the gas stream exiting the downstream end of the solar-thermal reactor “reaction” shell is fed to a cooling device. The cooling device provides for rapid cooling of the products of the reduction reaction. After cooling, the reduced metal oxide product can be collected. For this purpose a cyclone or other collection means, such as a filter arrangement, can be used.

In an embodiment, a fluid wall is provided in the solar-thermal reactor reaction shell and/or the cooling chamber. A fluid wall can be created along the reaction shell or along a cooling chamber wall by flow of a fluid-wall gas radially inward through holes or pores in the reaction shell or chamber wall. The fluid wall is designed and placed to limit recombination of the reduced metal oxide product with oxygen gas by limiting nucleation of oxide particles at the inner surface of the reaction shell or chamber wall. The fluid wall may also provide other benefits, such as reducing corrosion of the reaction shell.

In an embodiment, the invention provides a method for reducing metal oxide particles comprising the steps of:

a) providing a solar-thermal fluid-wall aerosol transport reactor comprising an at least partially transparent outer protection shell and an inner reaction shell having an inlet and an outlet, the reaction shell being partially porous and having a porous section located at the outlet end of the shell;

b) flowing a first gas stream comprising entrained metal oxide particles from the inlet to the outlet of the reaction shell;

c) flowing a second gas stream radially inward through the porous section of the reaction shell, thereby generating a fluid wall along the inside of the reaction shell; and

d) heating the metal oxide particles in the reactor at least in part with a source of concentrated sunlight through indirect solar thermal heating to a temperature at which the metal oxide particles undergo a reduction reaction, thereby producing a reduced metal oxide product which is a metal, a metal oxide of a lower valence state, or a combination thereof.

In another embodiment, the invention provides a method for reducing metal oxide particles comprising the steps of:

a) providing a solar reactor system comprising a solar-thermal aerosol transport reactor and a cooling device, the solar-thermal reactor comprising an at least partially transparent outer protection shell and a reaction shell having an inlet and an outlet and the cooling device comprising a cooling chamber having an inlet and an outlet and comprising an inner wall comprising a porous section, the inlet of the cooling chamber being connected to the outlet of the solar-thermal reactor reaction shell;

b) flowing a first gas stream comprising entrained metal oxide particles from the inlet to the outlet of the reaction shell;

c) flowing a second gas stream radially inward through the porous section of the inner cooling chamber wall, thereby generating a fluid wall along the inside of the inner cooling chamber wall;

d) heating the metal oxide particles in the reactor at least in part with a source of concentrated sunlight through indirect solar thermal heating to a temperature at which the metal oxide particles undergo a reduction reaction thereby producing a reduced metal oxide product which is a metal, a metal oxide of a lower valence state, or a combination thereof; and

e) cooling the reduced metal oxide product by discharging reduced metal oxide product into the cooling device.

In yet another embodiment, the invention provides a method for reducing metal oxide particles comprising the steps of

a) providing a reactor comprising a first inner shell which is partially porous and has a first inner shell inlet and outlet, a second inner shell which is nonporous and substantially encloses the first inner shell, an outer shell which is nonporous, at least partially transparent and substantially encloses the second inner shell, a first plenum substantially located between the first inner shell and the second inner shell and having a first plenum inlet and outlet, and a second plenum substantially located between the second inner shell and the outer shell and having a second plenum inlet and outlet wherein the first plenum outlet is formed by the pores of the first inner shell and the interior of the first inner shell is prevented from fluid communication with the first and second gas plenums inside the reactor, except for fluid communication between the interior of the first inner shell and the first gas plenum through the pores of the first inner shell;

b) flowing a first gas stream from the inlet to the outlet of the first inner shell;

flowing a second gas stream through the inlet of the first plenum, thereby causing at least part of the second gas stream to flow inwardly through the pores of the first inner shell;

c) flowing a third gas stream comprising a non-dissociating, non-oxidizing gas from the inlet to the outlet of the second plenum;

d) providing metal oxide particles in the first gas stream; and

e) heating the metal oxide particles at least in part with a source of concentrated sunlight through indirect solar thermal heating to a temperature at which the metal oxide particles undergo a reduction reaction.

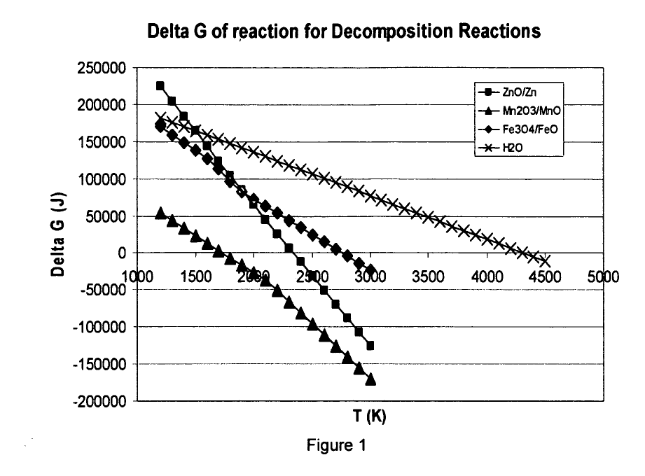

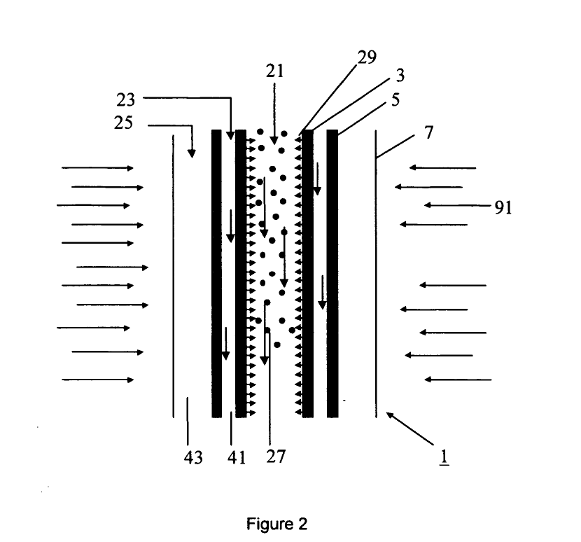

In an embodiment, the solar-thermal reactor has a fluid wall along at least a portion of the innermost reaction shell. FIG. 2 is a cross-section of the central portion of a solar-thermal fluid wall reactor. In the figures, the same numbers are used to identify like features. In the configuration shown in FIG. 2, the reactor (1) has a first, innermost, inner shell (3) which is at least partially porous, a second inner shell (5) which is non-porous, and an outer shell (7) which is at least partially transparent to solar radiation and is also non-porous. As used herein, “shells” encompass tubes, pipes or chambers which are elongated along a longitudinal axis. As used herein, a “porous” shell region permits gas flow through the walls of the region while a “nonporous” shell region does not. In a reactor with three shells, the first inner shell is substantially enclosed by the second inner shell and the outer shell and the second inner shell is substantially enclosed by the outer shell. As used herein, “substantially encloses” means that one shell is enclosed by another for most of the length of the shell. The ends of a shell that is substantially enclosed by another may extend past the ends of the other shell (e.g. the ends of the first inner shell may extend past the ends of the second inner shell and/or the outer shell). FIG. 1 illustrates an embodiment where the “shells” are concentric tubes of circular cross-section. In an embodiment, the solar thermal reactor is a solar-thermal fluid-wall reactor as described in United States Patent Application Publication US 2003/0182861 to Weimer et al., which is hereby incorporated by reference to the extent not inconsistent with the disclosure herein. United States Patent Application Publication 20030208959 and U.S. Pat. No. 6,872,378 to Weimer et al. are also hereby incorporated by reference.

FIG. 2 also illustrates the central portion of the first (41) and second (43) gas plenums. During operation of the reactor, gases are flowed through the first inner shell and the two gas plenums by connecting each of the respective inlets to at least one gas source. The porous region(s) of the first inner shell serve as an outlet to the first gas plenum. FIG. 2 illustrates three gas streams, a first gas stream (21) flowing through the first inner shell, a second gas stream (23) flowing through the first plenum, and a third gas stream (25) flowing through the second plenum. Preferably, the first gas stream is prevented from mixing with the third gas stream within the reactor and mixing between the first and second streams is limited to mixing within the first inner shell due to flow of gas from the second gas stream through the porous region(s) of the first inner shell. In other words, the interior of the first inner shell is preferably prevented from fluid communication with the first and second plenum inside the reactor, except for fluid communication between the first inner shell and the first plenum through the porous region(s) of the first inner shell. In addition, during operation of the reactor fluid communication between the interior of the first inner shell and the first plenum is primarily in the direction from the first plenum to the first inner shell. The pressure within the first plenum is high enough to overcome the resistance of the porous first inner shell and still have a pressure (at the instant the gas from the second gas stream leaves the pore) greater than the pressure inside the shell. Restricting fluid communication between the interior of the first inner shell and the first and second plenum can prevent deposition of particulate reaction products on the other shells and reduce the amount of gas from the second and third gas streams which enters the first inner shell. The overall volumetric flow rate of gases through the first inner shell can affect the residence time and the production throughput of the reactor. If the second and third gas streams are different, it is also preferred to prevent mixing of the second and third gas streams within the reactor.

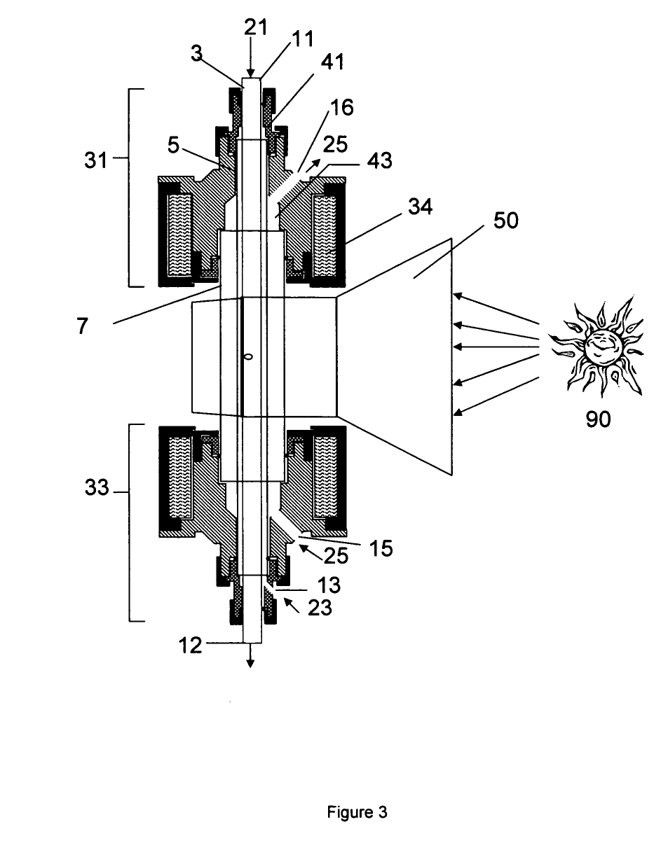

In one embodiment, mixing of the gas streams is restricted by seals. If the inner and outer shells are tubes as shown in FIG. 2, the plenums are further defined by these seals, since they serve to define the gas volume. Statement that a plenum is located “substantially between” two shells encompasses an extension of the plenum beyond the two shells into a sealing structure. In addition, a plenum being “substantially located” between two shells encompasses reactor configurations where other reactor elements, for example thermal insulation, are also located between the two shells. FIG. 3 illustrates one sealing configuration which can be used to prevent mixing of the gas streams within the reactor. In FIG. 3, the inlet and outlets for the inner and outer shells are illustrated as part of the sealing structures (31) and (33). The inner shell inlet (11) and outlet (12) are substantially sealed from the first plenum (41) and second plenum (43). FIG. 3 also shows the first plenum inlet (13), with the outlet of the first plenum being the porous region of the inner shell, and second plenum inlet (15) and outlet (16). The sealing structures shown in FIG. 3 are cooled with water (34) to prevent heat damage to the fitting and sealing materials. Other suitable seal configurations are known to those skilled in the art. Furthermore, the seal configuration may be different at the inlet and outlet ends of the reactor.

The reactor shown in FIG. 2 is operated generally as follows. Concentrated solar-thermal radiation (91) passes through the outer “protection” shell (7) and directly heats the second inner “heating” shell (5). The nonporous heating shell re-radiates from its inner wall and heats the first inner “reaction” shell (3). Hence, the inner “reaction” shell (3) is heated indirectly by concentrated sunlight from the surrounding “heating” shell (5). The inner “reaction” shell (3) re-radiates from the inner wall and heats the metal oxide particles (27) and first gas stream (21) flowing through it. When heated, the metal oxide particles undergo the desired reaction(s). As the first gas stream is heated and the desired reaction(s) occur, one or more product gases are added to the gas stream. A second gas stream (23) of “fluid-wall” gas flows in the annular region between the central “heating” shell and the inner “reaction” shell. The “fluid-wall” gas enters the first plenum between the inner and outer shell through an inlet and exits the plenum through an outlet. One outlet of the first plenum is the porous section of the inner shell. An additional outlet for the first plenum may be used, so long as sufficient gas flow is provided through the porous section of the inner shell. The “fluid-wall” gas flows through the pores of the porous section of the “reaction” shell (3), exits radially along the inside of the “reaction” shell and provides for an inner “fluid-wall” gas blanket (29). After entering the first inner shell, the “fluid-wall” gas exits through the outlet of the first inner shell. A third gas stream (25) of non-oxidizing and non-dissociating “purge” gas flows in the annular region between the outer “protection” shell and the central “heating” shell, thus preventing oxidation of the central “heating” shell and any insulation that may be present between the “protection” and “heating” shell.

In another embodiment, the reactor comprises

a) an inner shell which is at least partially porous, the inner shell having an inlet and an outlet;

b) an outer shell which is nonporous, at least partially transparent, and which substantially encloses the second inner shell; and

c) a gas plenum located substantially between the inner and outer shell, the plenum having an inlet and an outlet, wherein the reactor is heated at least in part by a source of concentrated sunlight and the only fluid communication between the inner shell and the gas plenum inside the reactor occurs through the pores of the inner shell.

This reactor is operated as follows. Concentrated solar-thermal radiation passes through the outer “protection” shell and directly heats the inner “reaction” shell. The inner “reaction” shell re-radiates from the inner wall and heats the metal oxide particles and first gas stream flowing through it. When heated, the metal oxide particles undergo the desired reaction(s). A second gas stream of “fluid-wall” gas flows in the annular region between the outer “protection” shell and the inner “reaction” shell. The “fluid-wall” gas enters the plenum between the inner and outer shell through an inlet and exits the plenum through an outlet. The porous section of the inner shell forms one outlet of the plenum. An additional outlet for the plenum may be used, so long as sufficient gas flow is provided through the porous section of the inner shell. The “fluid wall” gas flows through the pores of the porous section of the “reaction” shell, exits radially along the inside of the “reaction” shell and provides for an inner “fluid-wall” gas blanket.

In general, the shells comprising the reactors of the invention may be positioned vertically or horizontally, or in any other spatial orientation. For the case of a vertical reaction shell process, the apparatus may be arranged to provide upward or downward flow of the gas stream and the cloud of particles. Upward flow guarantees that aggregated particles will not be carried through the reaction shell. Downward flow reduces the potential for plugging in the solids feed line. Preferably, the reactor shell is positioned vertically and flow is downward.

The innermost inner shell (the first inner shell in a three-shell reactor) has an inlet and an outlet for the first gas stream. The inlet end of the inner shell is the upstream end of the shell, while the outlet end is the downstream end. The interior of the innermost shell defines a reaction chamber within which the high temperature reaction takes place. The innermost shell is capable of emitting sufficient radiant energy to raise the temperature of the reactants within the reaction chamber to a level required to initiate and sustain the desired chemical reaction. The innermost shell is made of a high temperature refractory material. The refractory material subsequently heats flowing metal oxide particles flowing through the first inner shell. In an embodiment, the refractory material is substantially chemically unreactive with the particles or the reactant or product gases. In an embodiment, the innermost shell is graphite. In other embodiments, the innermost shell is silicon carbide or a refractory metal or alloy capable of withstanding the temperature required for a given decomposition reaction. Other suitable high temperature ceramics include hafnium boride, hafnium carbide, and silicon carbide-silicon carbide composites.

In an embodiment, the innermost shell is at least partially porous. The innermost shell may be wholly of porous material or may comprise one or more regions of porous material. The porous region(s) of the innermost shell are selected so that sufficient uniform flow of gas occurs radially inward through the pores to provide a fluid-wall protective blanket for the radially inward surface of the innermost shell. The porosity of the porous region(s) can be varied and is selected on the basis of the required gas flow and allowable pressure drop to provide for a fluid-wall of gas. The length of the porous section(s) of the “reaction” shell can be varied and is determined by the zone where oxidation of the “reaction” shell or heterogeneous nucleation is most likely to occur. The placement of the porous section along the length of the “reaction” shell is determined by the same considerations. In an embodiment, the length of the porous section of the “reaction” shell is limited to where it is needed. The entry of fluid-wall gas into the “reaction” shell increases the overall volumetric flow rate of gases through the “reaction” shell, thus reducing residence time and limiting the production throughput of the reactor. In an embodiment, the porosity in a given porous region is substantially uniform.

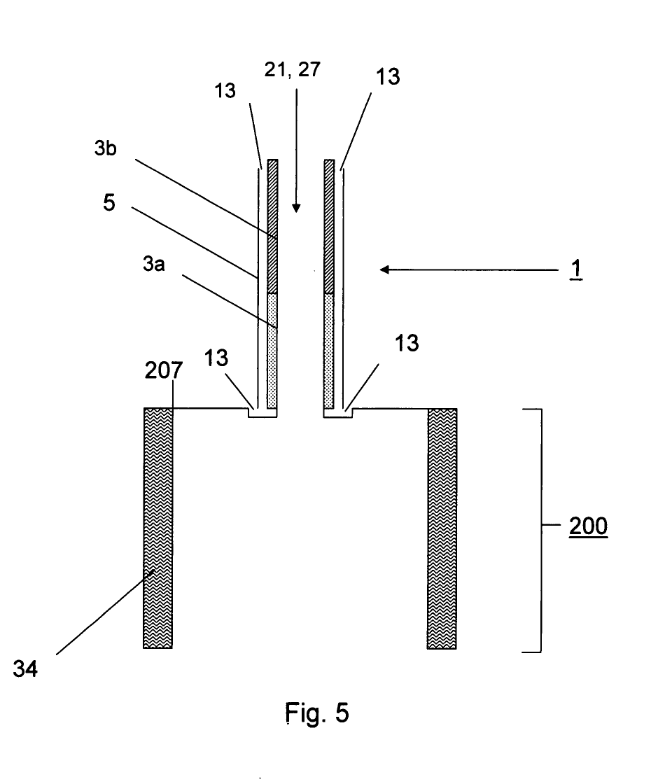

In an embodiment, the reaction shell is only partially porous. In an embodiment, as shown in FIG. 5, the porous section is located at the downstream end of the reaction shell. This configuration is used to reduce recombination of the reduced metal oxide product with oxygen and localizes the fluid wall to the region where the concentration of the reduced metal oxide product is highest. In different embodiments, the ratio of the length of the porous section of the shell to the nonporous section of the shell is between about 1:2 and about 1:1 or between about 1:1 and about 2:1. In another embodiment, the innermost shell may take the form of a graphite tube having a central porous region with nonporous ends

A partially porous reaction tube may be made by joining together a porous tube and a solid tube. Graphite tubes may be joined by high temperature sintering using a carbon-containing paste. Silicon carbide tubes may also be joined by sintering with the appropriate sintering aid.

In another embodiment, the reaction shell is nonporous, and the solar-thermal reactor is connected to a cooling device designed to minimize recombination of oxygen with the reduced metal oxide product prior to condensation of the reduced metal oxide product. In an embodiment, the cooling device incorporates a fluid-wall.

In different embodiments, the ratio of the length of the reaction shell to the inner diameter of the reaction shell is between 5 and 30, between 5 and 10, and between 20 and 25.

A second inner shell substantially enclosing the first inner shell may be present, but is not required. If no second inner shell is present the “reaction” shell is heated directly by concentrated sunlight passing through the “protection” shell and “fluid wall” gas is flowed in the plenum substantially located between the “reaction” shell and the “protection” shell.

The use of a second inner shell offers several advantages. The use of a nonporous second inner shell distances the “fluid wall” gas from the outer “protection” shell, which can increase the safety of the process when the “fluid wall” gas is a flammable gas such as hydrogen. Furthermore, if the second inner shell is a tube made of a material such as graphite, an electrical current can be run from one end of the tube to the other and generate additional heat for the process through resistance heating of the tube. This additional heat can supplement the process at times when the source of concentrated sunlight does not provide the desired amount of energy (e.g. a cloudy day).

Typically, the second inner shell is composed of nonporous high temperature refractory material. The second inner shell is most preferably made of solid graphite. As previously discussed, the second inner shell can function as a “heating” shell, since it radiates heat to the innermost shell. In addition, the combination of the first and the second inner shell at least partially defines a first plenum or volume for the fluid-wall gas.

Additional inner shells can be used in the process. If used, they are sized and positioned so that the innermost shell is enclosed by each of the other reactor shells (i.e. the reactor shells are substantially “nested” one inside the other). If additional inner shells are used, “purge” gas can be used to prevent oxidation of these shells as well.

The outer “protection” shell is at least in part transparent or semi-transparent to the concentrated sunlight, thereby allowing concentrated sunlight to flow through and heat the inner shell(s) of the reactor. The “protection” shell is made of a high temperature material that is oxidation resistant. A suitable material for the transparent portion of the outer shell is quartz. The transparent portion of the outer shell may be a transparent section, window or opening to allow the concentrated sunlight into the vessel. The shell wall transparent area, allowing for concentrated sunlight entry and subsequent solar thermal heating, should be selected to provide heating during the desired reaction residence time requirements for the process.

The outer shell may be made entirely of quartz. In this case, the sections of the internal wall of the shell where sunlight is not being concentrated and entering the vessel, may be coated with a reflective material, such as silver or gold, to keep the concentrated sunlight inside the reactor. If such a reflective coating is used, there must be an uncoated transparent section, window or opening to allow the concentrated sunlight into the vessel.

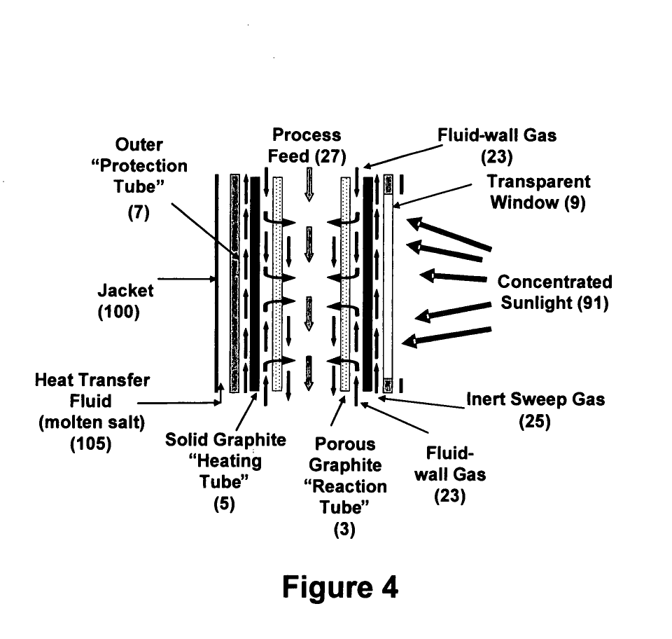

Alternatively, the outer “protection” shell may be made of a refractory non-transparent material with a section containing a transparent window where concentrated sunlight can enter, as schematically illustrated in FIG. 4. In an embodiment, the transparent window may be a rectangular vertical quartz window (with the long axis of the rectangle aligned perpendicular to the longitudinal axis of the reactor).

In the configuration shown in FIG. 4, both a first (3) and a second inner shell (5) are substantially enclosed by the outer shell. The “heating” shell (5) is directly exposed to concentrated sunlight in the section of the shell located in the path of the sun through the transparent section (9) of the “protection” shell (7). It is also possible to provide cooling of the outer metal refractory “protection” shell, particularly in the region immediately surrounding the transparent window allowing concentrated sunlight to directly heat the “heating” shell. The non-transparent refractory material may be a metal with a sufficiently high melting point, such as stainless steel. A metal “protection” shell can be plated with gold to reflect infrared (IR) radiation back to the “heating” shell. As shown in FIG. 4 at least part of the non-transparent part of the “protection” shell can be surrounded by heat transfer fluid (105) contained by a jacket (100). The heat transfer fluid can be a molten salt such as a mixture of sodium and potassium nitrates. Molten salts are capable of operating at temperatures up to about 500° C. Use of such a cooling jacket can allow for significantly improved efficiency. The “heating” shell may be surrounded by refractory insulation in the region where it is not directly exposed to concentrated sunlight via the transparent section. The insulation may be concentrically placed and extends substantially from the “heating” shell to the concentric “protection” shell, although it may not completely fill the space between the heating shell and the protection shell. The refractory insulation can be a combination of graphite insulation near the “heating” shell and an alumina type refractory insulation near the “protection” shell. This design arrangement allows concentrated sunlight to enter through a transparent section and heat the “heating” shell while the surrounding insulation reduces conductive and convective losses of energy from the “heating” shell, thereby increasing the efficiency of the process.

The combination of the outermost inner shell and the outer shell at least partially defines a plenum or volume for gas. If no second inner shell is used in the reactor, fluid-wall gas flows in the space between the outer shell and the inner shell. Otherwise, a non-oxidizing and non-dissociating “purge” gas typically flows between a second plenum substantially located between the outer shell and the second inner shell to protect the second inner “heating” shell from oxidation. The purge gas may be argon, helium, neon, or any other chemically inert gas.

In the methods of the invention, metal oxide particles are heated at least in part with a source of concentrated sunlight (91). The reactors may be heated by solar energy alone or by a combination of solar energy and resistance heating of one of the shells of the reactor. The source of concentrated sunlight (91) may be a solar concentrator (50), as shown in FIG. 3. This figure also shows unconcentrated sunlight (90) entering the solar concentrator. Preferably, the solar concentrator of the apparatus is designed to optimize the amount of solar thermal heating for the process. Solar fluxes between about 1500 and about 2000 kW/m² have been shown to be sufficient to heat the particles to temperatures between 1675 and 1875 K. More preferably, solar fluxes between about 2000 and 5000 kW/m² are desired to achieve even higher temperatures and reactor throughputs. Most preferably, reaction temperatures are approximately 2100 K.

The temperature inside the innermost shell of the reactor can be measured with a thermocouple. Alternatively, temperatures inside the reactor can be measured with an optical pyrometer. For a three-shell reactor, the hot zone temperature measured with an optical pyrometer is typically the temperature of the nonporous “heating” shell, since the “heating” shell encloses the “reaction” shell in the hot zone. The temperature inside the inner “reaction” shell may be less than that of the “heating” shell due to thermal losses due to heating the porous shell and the gases in the first plenum and the reaction shell. As used herein, the dissociation temperature of a metal oxide is the temperature at which the metal oxide dissociates into oxygen and the reduced metal oxide product. In an embodiment, the temperature within reaction shell of the solar-thermal reactor is greater than the dissociation temperature of the metal oxide particles in the hot zone and from the hot zone to the downstream end of the reactor. For the ZnO/Zn system, the temperature in the reaction shell of the solar-thermal reactor in and downstream of the hot zone is preferably greater than about 1600° C.

The sunlight can be provided in the form of a collimated beam (spot) source, a concentric annular source distributed circumferentially around the reactor, or in the form of a linearized slot source providing heating axially along the length of reactor. The light can be redirected and focused or defocused with various optical components to provide the concentration on or in the reactor as required. An example of a suitable solar concentrator for use in the present invention is the High-Flux Solar Furnace (HFSF) at the National Renewable Energy Laboratory (NREL) in Golden, Colo. The HFSF uses a series of mirrors that concentrate sunlight to an intensified focused beam at power levels of 10 kW into an approximate diameter of 10 cm. The HFSF is described in Lewandowski, Bingham, O'Gallagher, Winston and Sagie, “Performance characterization of the SERI Hi-Flux Solar Furnace,” Solar Energy Materials 24 (1991), 550-563. The furnace design is described starting at page 551, wherein it is stated,
The performance objectives set for the HFSF resulted in a unique design. To enable support of varied research objectives, designers made the HFSF capable of achieving extremely high flux concentrations in a two-stage configuration and of generating a wide range of flux concentrations. A stationary focal point was mandatory because of the nature of many anticipated experiments. It was also desirable to move the focal point off axis. An off-axis system would allow for considerable flexibility in size and bulk of experiments and would eliminate blockage and consequent reduction in power.
In particular, achieving high flux concentration in a two-stage configuration (an imaging primary in conjunction with a nonimaging secondary concentrator) dictates a longer f/D [ratio of focal length to diameter] for the primary [concentrator] than for typical single-stage furnaces. Typical dish concentrators used in almost all existing solar furnaces are about f/D=0.6. To effectively achieve high flux concentration, a two-stage system must have an f/D=2. Values higher than this will not achieve significantly higher concentration due to increased losses in the secondary concentrator. Values lower than this will result in a reduction of maximum achievable two-stage flux. At low values of f/D, the single stage peak flux can be quite high, but the flux profiles are also very peaked and the average flux is relatively low. With a longer f/D, two-stage system, the average flux can be considerably higher than in any single-stage system. The final design of the HFSF has an effective f/D of 1.85. At this f/D, it was also possible to move the focal point considerably off axis (˜30°) with very little degradation in system performance. This was because of the longer f/D and partly because of the multi-faceted design of the primary concentrator. This off-axis angle allows the focal point and a large area around it to be completely removed from the beam between the heliostat and the primary concentrator.

When the outer shell is wholly transparent or has a window which extends completely around the shell, the concentrated sunlight is preferably distributed circumferentially around the reactor using at least one secondary concentrator. Depending upon the length of the reaction shell, multiple secondary concentrators may be stacked along the entire length of the reaction shell. For the HFSF described above, a secondary concentrator that is capable of delivering 7.4 kW of the 10 kW available (74% efficiency) circumferentially around a 2.54 cm diameter×9.4 cm long reaction tube has been designed, constructed, and interfaced to the reactor.

The invention also provides reactor systems which combine the reactor of the invention with one or more other system elements. System elements useful for use in the present invention include, but are not limited to, particle dispersion and feeding devices, sources of concentrated solar energy, cooling zones, filtering devices, various purification devices, hydrogen storage devices, and thermophotovoltaic devices.

A cooling zone may be provided by a cooling device comprising a cooling chamber. The cooling chamber is connected to the solar-thermal reactor so that the gas stream exiting the reaction shell of the reactor and comprising the reduced metal oxide product enters the cooling chamber. The reduced metal oxide product is thereby discharged into the cooling chamber. In the cooling zone, the products of the reduction reaction can cool from reaction temperature to chamber wall or fluid-wall gas temperature in less than one second. When the reduced metal oxide product enters the cooling device in gas form, particle nucleation occurs within the cooling device.

In different embodiments, the cooling device may have an expanded diameter (a diameter that is larger than the diameter of the solar-thermal reactor reaction shell), a fluid-wall, or a combination of an expanded diameter and a fluid wall. The upstream end of the cooling device is connected to the downstream end of the solar-thermal reactor. The connection between the cooling device and the solar-thermal reactor may be made via a water-cooled connector that provides o-ring sealing of the solar-thermal reactor shells and gas inlets and/or outlets. The walls of the cooling chamber are maintained below the melting temperature of the reduced metal oxide product. In an embodiment, the walls of the cooling chamber are maintained below 400° C. With water cooling, the walls of the cooling chamber can be maintained below 100° C.

In the cooling zone, products can cool from reaction temperature to chamber wall or fluid-wall gas temperature in less than one second. When the reduced metal oxide product enters the cooling device in gas form, particle nucleation occurs within the cooling device.

FIG. 5 illustrates a fluid wall solar-thermal reactor connected to a cooling device (200) with an expanded diameter; (the outer “protection tube” of the reactor is not shown). The cooling chamber's expanded configuration can serve multiple purposes, which include but are not limited to cooling by gas expansion and reduction of recombination of product oxygen with reduced metal oxide product. In an embodiment, the diameter of the cooling chamber is selected to be at least three times the diameter of the solar-thermal reactor reaction shell. As used herein, the diameter is the greatest distance across a given cross-sectional area and thus can refer to the greatest distance across a circular or elliptical cross-section, or the diagonal length of a rectangular cross-section. If the cooling chamber contains a plurality of nested walls (e.g. an inner partially porous wall and a nonporous outer wall), the diameter of the cooling chamber is the inner diameter of the chamber. In an embodiment, the length of the cooling zone is between one-half the length of the solar-thermal reactor length and the length of the solar-thermal reactor.

The solar-thermal reactor shown in FIG. 5 has a partial fluid wall with fluid-wall gas inlets (13) at the upstream and downstream ends of the reactor. The reaction shell comprises a porous portion (3a) and a non-pourous portion (3b). The connection between the solar-thermal reactor and the cooling chamber is made so that the gas plenum between the reaction tube (3a, 3b) and the heating tube (5) is not in fluid communication with the cooling chamber. FIG. 5 also indicates water cooling (34) of the cooling chamber wall (207).

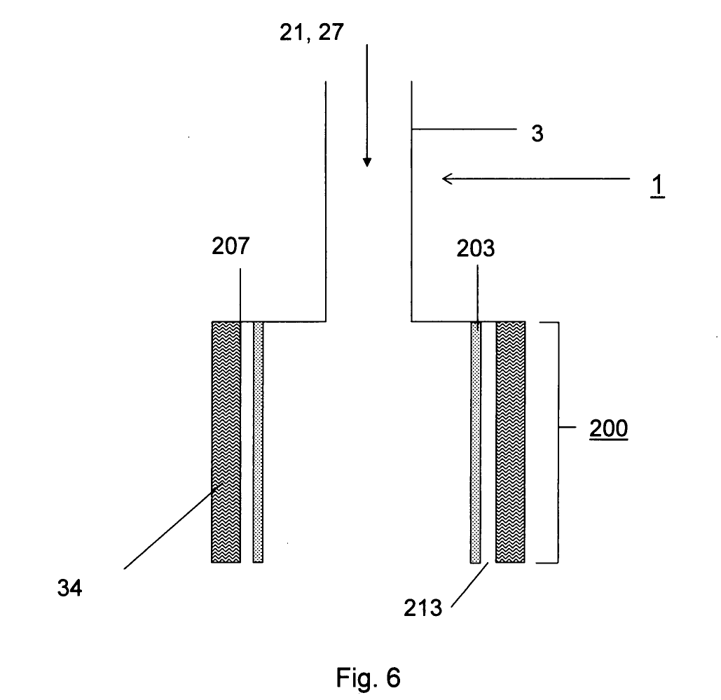

When a fluid wall is provided in the cooling chamber, the diameter of the cooling chamber may be the same or greater than that of the inner shell in the solar-thermal reactor. FIG. 6 illustrates a solar-thermal reactor without a fluid wall connected to an expanded cooling chamber with a fluid wall; only the inner reaction tube (3) of the reactor is shown. The reaction tube of the reactor is connected to the top of the cooling chamber, which in turn is connected to an inner (203) and an outer (207) chamber side wall (207). As shown in FIG. 6, the fluid wall may extend the length of the cooling chamber. The fluid wall length may also be shorter than the length of the cooling chamber, so long as thermophoretic deposition on the cooling device walls is not excessive. Preferably, the fluid wall in the cooling chamber is created by flowing a fluid-wall gas radially inward through one or more porous sections of the inner chamber wall. FIG. 6 also shows creation of a fluid wall by flowing a fluid-wall gas between a nonporous outer chamber wall (207) and a porous tube inner chamber wall (203), with the fluid-wall gas inlet (213) located at the downstream end of the cooling chamber. In an embodiment, the fluid-wall gas is at room temperature before being introduced into the cooling chamber The fluid-wall gas may also be preheated before it is introduced into the solar-thermal reactor. FIG. 6 also shows water cooling (34) of the outer wall (207) of the cooling chamber.

The cooling chamber can be essentially cylindrical, elliptical, rectangular, or of other effective configuration. The chamber may be cooled by a water-cooling jacket or a cool gas quenching system, such as are known to those skilled in the art.

In an embodiment, the invention provides a solar-thermal reactor system comprising

a) a solar-thermal aerosol transport reactor comprising a partially porous first inner shell having an inlet and an outlet and a porous section located at the outlet end of the first inner shell, a second inner shell substantially enclosing the first inner shell, an at least partially transparent outer shell substantially enclosing the second inner shell, a first gas plenum located substantially between the first and second inner shell, the first gas plenum having an inlet and an outlet, and a second gas plenum located substantially between the second inner shell and the outer shell, the second gas plenum having an inlet and an outlet; and

b) a cooling device comprising a cooling chamber having an inlet and an outlet, the inlet of the cooling chamber being connected to the outlet of the solar thermal reactor first inner shell and the inner diameter of the cooling chamber being greater than the inner diameter of the first inner shell.

In another embodiment, the invention provides a solar-thermal reactor system comprising

a) a solar-thermal aerosol transport reactor comprising a nonporous first inner shell having an inlet and an outlet, a second inner shell substantially enclosing the first inner shell, an at least partially transparent outer shell substantially enclosing the second inner shell, a first gas plenum located substantially between the first and second inner shell, the first gas plenum having an inlet and an outlet, and a second gas plenum located substantially between the second inner shell and the outer shell, the second gas plenum having an inlet and an outlet;

b) a cooling device comprising a cooling chamber having an inlet and an outlet and comprising an inner first wall comprising a porous section and a second wall substantially enclosing the first wall and a third gas plenum located substantially between the first and second wall, the third gas plenum having an inlet and an outlet, the inlet of the cooling device being connected to the outlet of the first inner shell of the solar-thermal reactor.

The process of the present invention uses concentrated sunlight to transfer heat at extremely high rates by radiation heat transfer to metal oxide particles flowing in dilute phase in an entrainment gas. The heating to the particles is generally carried out indirectly from a heated wall or series of walls which are themselves heated indirectly or heated directly by solar-thermal radiative heating. In an embodiment, the inside most wall (“reaction”) of the solar-thermal reactor is at least partially fabricated of a porous refractory material with a compatible “fluid-wall” gas flowing inward, thus, providing a blanket of gas. The gas blanket can reduce oxidation of the inside most wall and/or can limit heterogenous nucleation from the inside most wall.

As used herein, the “residence time” is the time that the metal oxide particles spend in the hot zone of the innermost “reaction” shell. The hot zone length may be estimated as the length of the reactor directly irradiated by the source of concentrated sunlight. The residence time depends on the reactor dimensions, such as the hot zone length and the inner diameter of the “reaction” shell. The residence time also depends on the flow rate of the first gas stream containing the metal oxide particles and the flow rate of the fluid-wall gas through the pores of the inner shell. The residence time may be calculated through modeling or estimated from ideal gas considerations. In an embodiment, the residence time is between about 0.5 and about 2 seconds.

The metal oxide particles are dispersed in the reactor apparatus, and the form of dispersion is important. Preferably, the particles flow as a dust or particle cloud through the apparatus, dispersed in a dispersing process gas. They should have a fine primary particle size, preferably in the sub-micron size range, and be non-agglomerated. Several different methods can be used to disperse the particles. The particles can be dispersed mechanically, such as by shearing on the surface of a rotating drum or brush. Alternatively, the particles can be dispersed using the shear provided by high velocity gas exiting with the particles from a feed injection tube. Experience has shown that the exiting “tip speed” from the injection tube should be at least 10 m/s to provide the shear necessary for complete dispersion of fine powders.

The first gas stream is selected so that it is compatible with the metal oxide particle reduction process and the “reaction” wall of the solar-thermal fluid-wall reactor. In an embodiment, the first gas stream is an inert gas. The second gas stream may be helium, which can be easier to separate from oxygen than argon. Some metal oxide reactions can also be run in air. For these reactions, the first gas stream may be air if the “reaction” wall is not of graphite. When the first gas stream is air, the “reaction” wall may be of silicon carbide.

In general, the radiation absorbing particles flow co-currently with the flowing first gas stream through a reaction shell. The shell may be oriented horizontally or vertically. For the case of a vertical reaction shell process, the flow direction may be upward or downward. Upward flow guarantees that aggregated particles will not be carried through the reaction shell, and downward flow reduces the potential for plugging in the solids feed line. A preferred flow direction is downward with particles generated internally and separated downstream.

The fluid-wall gas is selected to be compatible with the reactants and the products. The fluid-wall gas is compatible if it allows the desired reaction to take place and/or is not difficult to separate from the gas stream exiting the “reaction” shell and/or the cooling device. The fluid-wall gas used in the solar-thermal reactor is also selected so that it is compatible with the “reaction” shell. If the reduction reaction can be run in air, the fluid-wall gas may be air if the “reaction shell” is not of graphite. When the fluid-wall gas used in the solar-thermal reactor is air, the “reaction” shell may be of silicon carbide. The gas stream used to provide the “fluid-wall” blanket gas flowing inward from the porous “reaction” shell wall is also preferably not a dissociating gas whose dissociation products would plug the pores of the porous wall. Inert gases, such as helium, N₂ or argon are suitable for use as the fluid-wall gas. In an embodiment, the fluid-wall gas is helium, which can be easier to separate from oxygen than argon. In an embodiment, the fluid-wall gas is not hydrogen.

In reactors having a first and second inner shell and an outer shell, a third gas stream comprising a non-oxidizing and non-dissociating “purge” gas flows between the outermost “transparent or semi-transparent “protection” shell and the solid “heating” shell. This “purge” gas can be hydrogen or an inert gas such as helium, N₂, argon or neon.

The present invention also provides methods for producing hydrogen via the thermochemical dissociation of water using concentrated solar energy. Both two-step and three-step metal oxide cycles for dissociation of water can be used.

The first reaction step, a metal oxide decomposition step, occurs within the solar-thermal reactor. During metal oxide decomposition, the particles of the first metal oxide are decomposed and can be reduced to a metal or to a second metal oxide of a lower valence state. Oxygen is also produced during the decomposition reaction. The oxygen is separated from the metal or the second metal oxide prior to the next reaction step in the cycle. If both reaction products are in gaseous form, the metal or metal oxide can be cooled to a condensed form to facilitate its separation from oxygen. During such a cooling step, recombination of the metal or metal oxide with oxygen is preferably minimized. Recombination of the metal or metal oxide with oxygen can be minimized by rapid cooling or quenching of the reaction products. In an embodiment, the heat removed from the system during such a cooling step is recovered. In a closed cycle, the entrainment and/or fluid-wall gases are also separated from the oxygen and recycled. Suitable gas-solid and gas separation processes are known to those skilled in the art. Gas-solid separation devices suitable for use with the invention include, but are not limited to, filtration and cyclones. Suitable gas separation techniques include, but are not limited to, pressure swing adsorption and vacuum swing adsorption.

In a two-step metal oxide cycle, the second reaction step is a hydrogen liberating step in which the metal or the second metal oxide of a lower valence state is reacted with water vapor to produce hydrogen and to recover the first metal oxide. The hydrogen is then separated from the first metal oxide before the cycle is repeated.

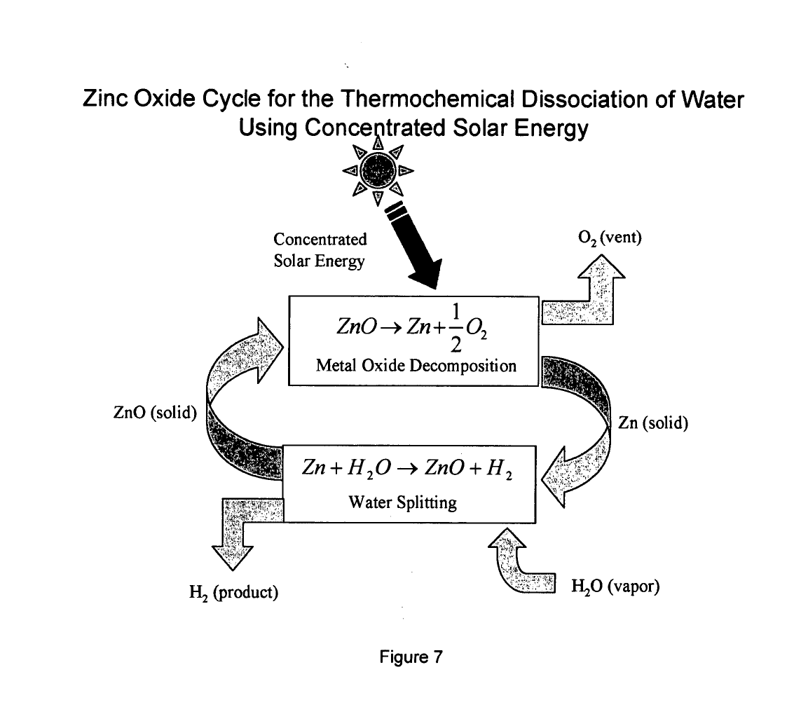

FIG. 7 shows a schematic of a two step zinc oxide cycle for the thermochemical dissociation of water using concentrated solar energy. Separation of oxygen from zinc vapor may be achieved by cooling the products of the decomposition reaction so that the zinc solidifies. In an embodiment, the Zn particles produced are submicron. In this system, the hydrogen liberation step is exothermic.

Other two step metal oxide cycles include ferrite cycles. Ferrites known to react with water to produce hydrogen include nickel manganese ferrites [35] and zinc manganese ferrites [36]. Nickel manganese ferrites include Ni0.5Mn0.5Fe₂O₄, which dissociates at high temperature to produce an activated, oxygen deficient form, Ni0.5Mn0.5Fe2O(4-delta).

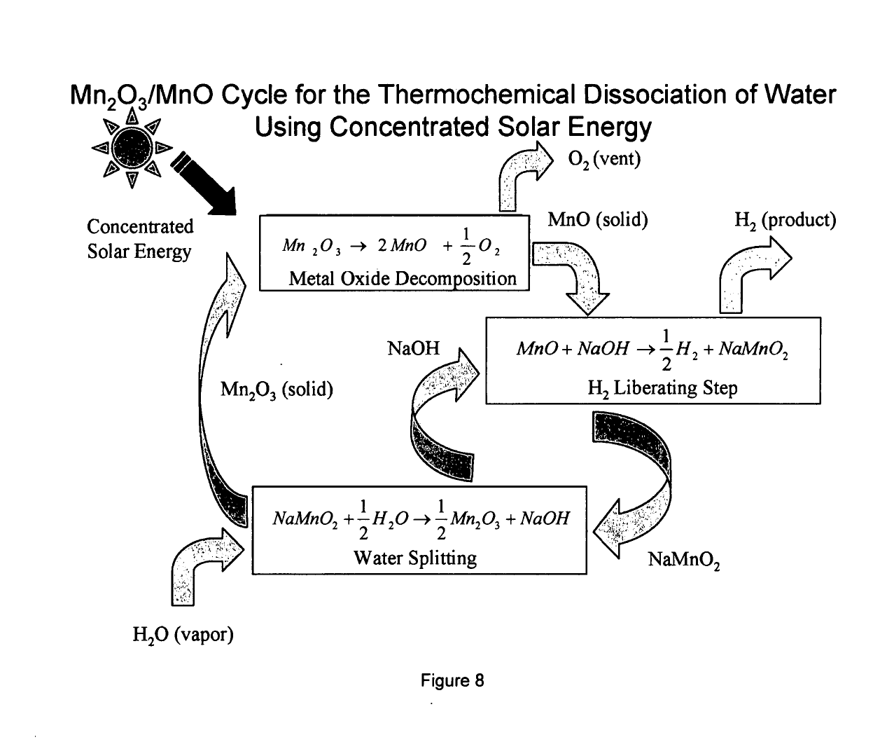

In a three-step metal oxide cycle, the second reaction step can be the hydrogen liberating step. In an embodiment, the hydrogen liberating step is the reaction of the second metal oxide with an alkali metal hydroxide, producing hydrogen and an alkali metal oxide. Suitable alkali metal hydroxides include sodium hydroxide (NaOH) and potassium hydroxide (KOH). The hydrogen is separated from the alkali metal oxide before the next reaction step. The third reaction step is a water splitting step. In an embodiment, the water splitting step is the reaction of the alkali metal oxide with water vapor to recover the first metal oxide and the alkali metal hydroxide. The first metal oxide and the alkali metal hydroxide are separated before the cycle is repeated. FIG. 8 shows a schematic of a Mn₂O₃/MnO cycle for the thermochemical dissociation of water using concentrated solar energy.

Methods for transporting reaction products to a subsequent reaction step are known to those skilled in the art. Furthermore, reaction and separation steps following the metal oxide reduction step may be performed by any method known to those skilled in the art. These succeeding steps may be performed “off-sun.” “Off-sun” steps can be driven by energy collected by a solar receiver and directed to a molten salt energy storage system, allowing the entire process to be run on only solar energy.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

When a Markush group or other grouping is used herein, all individual members of the group and all combinations and subcombinations possible of the group are intended to be individually included in the disclosure.

One skilled in the art would readily appreciate that the present invention is well adapted to carry out the objects and obtain the ends and advantages mentioned, as well as those inherent therein. The devices and methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

Although the description herein contains many specificities, these should not be construed as limiting the scope of the invention, but as merely providing illustrations of some of the embodiments of the invention. Thus, additional embodiments are within the scope of the invention and within the following claims.

All patents and publications mentioned in the specification are indicative of the levels of skill of those skilled in the art to which the invention pertains. All references cited herein are hereby incorporated by reference to the extent that there is no inconsistency with the disclosure of this specification.

### EXAMPLES

### Example 1

### Simulations of the ZnO/Zn Cycle

The metal-oxide cycle that has been most researched in the technical literature is the ZnO/Zn cycle. As can be seen from FIG. 1, it has a ΔG_{f} of zero at 2255 K, making it feasible for modern solar reactor systems [11]. If the Zn is fully recovered in the decomposition step, and ZnO fully recovered in the water splitting step, it is possible to make the only reaction input H₂O and the only products O₂ and H₂, thus completing a renewable, sustainable cycle.

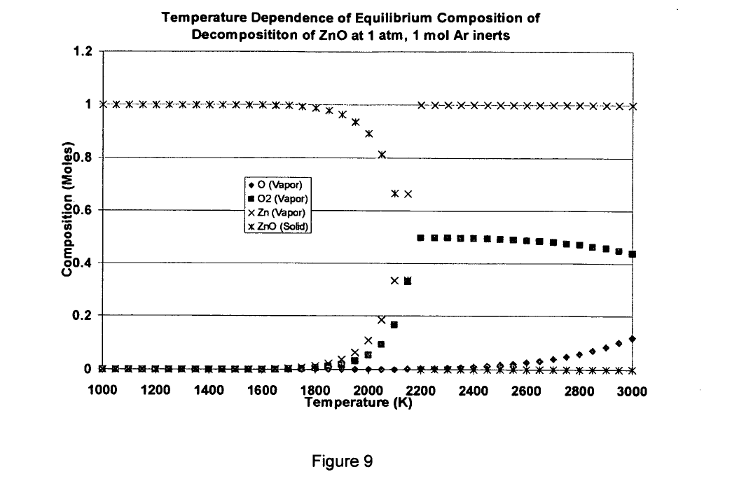

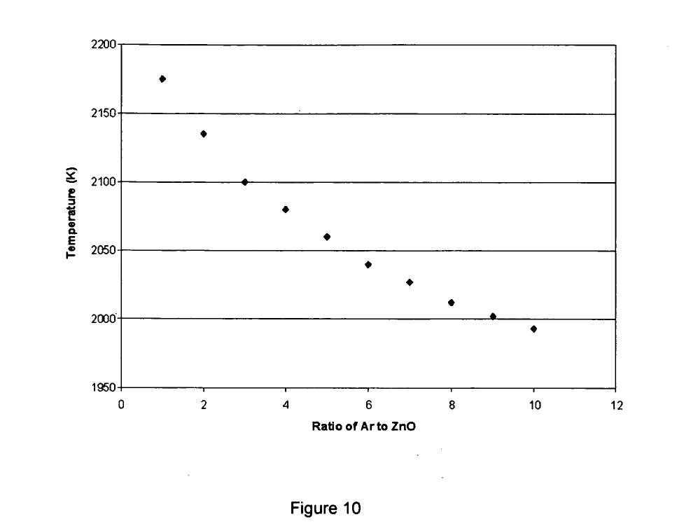

The ZnO decomposition reaction was simulated using the computer program FACT, and the equilibrium composition results of this simulation are shown in FIG. 9. As can be seen, FACT predicts the start of Zn vapor formation around 1800 K, with complete conversion occurring around 2150 K. At this point, only Zn, O₂, and some elemental oxygen are formed. Due to the unstable nature of elemental oxygen, this will most likely form the diatomic gas when temperatures are reduced in the post-reaction quench. The addition of more inert gas to carry the ZnO particles (argon or helium are the most likely candidates; helium is easier to separate from oxygen) reduces the necessary temperature for complete conversion of the ZnO predicted by FACT. This is a result of the reduced partial pressure of the product gases, shifting the reaction equilibrium toward the products. This temperature dependency is shown in FIG. 10. The necessary temperature for complete conversion dips below 2100 K for a molar feed ratio of 3:1. The decreased temperature will reduce reradiation losses, but it introduces an oxygen separation if one wishes to recycle the inert gas back to the system. Likewise, the enthalpy associated with heating inert gases needs to be considered.

As suggested by the thermodynamics, ZnO completely dissociates at temperatures around 2300 K. However, the major challenge of this cycle is the separation and concentration of the decomposition reaction products, Zn and O₂. At 2300 K, both species are gaseous (see FIG. 9). As the products cool, the reaction equilibrium shifts to ZnO and the desired products have a tendency to recombine. Recombination gives low yields of Zn, leading to low overall yields of H₂ and poor process economics. Palumbo et al. [12] suggest that a fast quench be used to cool the products to under 1200 K, where recombination kinetics are so slow as to be prohibitive. Using the kinetic data of Kashiraninov [12] predicts that a quench rate of 2×10⁷ K=s would be required to achieve 80% zinc recovery. However, their own experiments showed higher Zn yields with slower quench rates than this, suggesting a different kinetic mechanism than the homogenous elementary gas reaction proposed by early researchers in the field. Steinfeld et al. [11] showed that Zn and O₂ recombination is a heterogeneous process. In the absence of nucleation sites, it will not proceed. Little testing has been done on controlling the kinetics of this recombination reaction by engineering the surface chemistry. For improved results, Zn production in the first cycle step is maximized and zinc oxide formation in the quench step is mitigated.

### Example 2

### Simulations of the Mn₂O₃/MnO Cycle

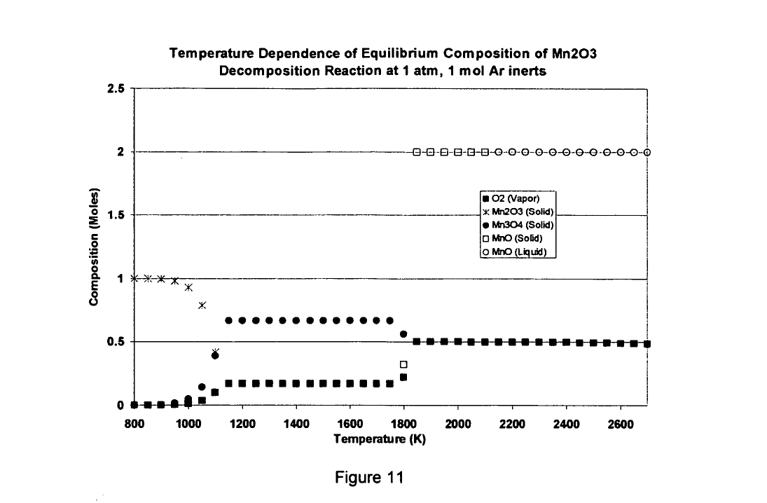

Thermodynamic simulation of the decomposition step of this reaction (Eq. (6)) was conducted using the FACT software. The equilibrium composition results of this simulation can be seen in FIG. 11. From these equilibrium data, a few interesting and desirable qualities of this system come to light. First, complete decomposition to solid phase MnO and gaseous O₂ occurs around 1800 K with an equimolar inert feed. This is at a lower temperature than required for the ZnO system, allowing for higher reactor efficiency due to lower reradiation losses. In addition, the separation of gaseous O₂ from solid MnO upon cooling is straightforward.

Additional calculations also show that Mn₂O₃ reduction is feasible in an air atmosphere.

### Example 3

### Demonstration of Production of Zn from ZnO at Moderate Residence Times in a Conventional Aerosol Flow Reactor

To demonstrate the efficacy of ZnO dissociation in high temperature aerosol flow, ZnO oxide (size approximately 900 nm-1 μm) particles were entrained in Argon gas and fed into a conventional aerosol flow reactor without a fluid wall. Conversions exceeding 20% were observed at moderate temperatures (1600° C.) and residence times (1.0 s). At higher temperatures, faster rates of Zn production were observed.

The product Zn particles had sizes ranging from 20 nm-400 nm. These small particles would likely be more reactive with water due to decreased mass and heat transfer limitations. The particles were collected on an HEPA filter and in a gravity collection vessel, and were well dispersed and non-agglomerated. The production of this Zn powder effectively demonstrates the concept of using an aerosol reactor for ZnO dissociation.

The cooling chamber consisted of a cylindrical, water cooled aluminum chamber positioned at the bottom of the reaction flow region. The zone was expanded to 3 times the cross-sectional diameter of the reaction zone, and was one-third the length of the furnace hot zone.

### Example 4

### Demonstration of Production of MnO from Mn₂O₃ at Moderate Residence Times in a Conventional Aerosol Flow Reactor

Mn₂O₃ particles (size 325 mesh, approximately 10-40 μm) were entrained in Argon gas and fed into a conventional aerosol flow reactor without a fluid wall. MnO formation was observed at temperatures of 1600, 1750, 1900 and 2150° C. for residence times of 1.0 and 1.5 s. MnO formation was also observed at temperatures of 1900° C. and 2150° C. for residence times of 0.5 s. At 2150° C., the MnO product was liquid. Conversion in excess of 0.65 was observed at 1900° C. for residence times of 1 second.

The cooling chamber consisted of a cylindrical, water cooled aluminum chamber positioned at the bottom of the reaction flow region. The zone was expanded to 3 times the cross-sectional diameter of the reaction zone, and was one-third the length of the furnace hot zone.

### Example 5

### On-Sun Demonstration of ZnO Dissociation in a Graphite Fluid Wall Reactor

ZnO particles (size approximately 900 nm-1 μm) were entrained in inert Argon gas and flowed down the central “reaction” tube in a graphite fluid wall reactor at High Flux Solar Furnace, part of the National Renewable Energy Laboratory, Golden, Colo. (Argon fluid wall gas). Temperatures as high as 2150° C. were observed on the reaction tube, and conversions as high as 3% were obtained in residence times ranging between 20 and 50 ms. Small amounts of Zn powder were collected in a downstream HEPA filter, proving the existence of ZnO dissociation. This demonstrates the use of a solar fluid wall reactor for the first-step in a two step metal oxide water splitting cycle. Higher conversion rates would be expected for longer residence times.

Cooling of products was performed in a stainless steel tube of equal diameter to the reaction tube and a length 3 times that of the reactor tube. The stainless steel tube was wrapped in copper tubing, through which a water/glycol cooling mix at 10° C. was flowed. Cooling occurred by radiation, conduction, and convection.

### REFERENCES

[1] Brown L C, Besenbruch G E, Schultz K R, Marshall A C, Showalter S K, Pickard P S, Funk J E. Nuclear production of hydrogen using thermochemical water-splitting cycles. In International Congress on Advanced Nuclear Power Plants, Hollywood, Fla., 2002.
[2] Bockris J O, Dandapani B, Cocke D, Ghoroghchian J. On the splitting of water. Int J Hydrogen Energy 1985;10(3): 179-201.
[3] Kogan A, Spiegler E, Wolfshtein M. Direct solar thermal splitting of water and on-site separation of the products. III. Improvement of reactor efficiency by steam entrainment. Int J Hydrogen Energy 2000;25(8):739-45.
[4] Kogan A. Direct solar thermal splitting of water and on-site separation of the products—IV. Development of porous ceramic membranes for a solar thermal water-splitting reactor. Int J Hydrogen Energy 2000;25(11):1043-50.
[5] Hammache A, Bilgen E. Evaluation of thermal efficiency and cost of high-temperature solar heat from central receiver systems to use in hydrogen producing thermochemical processes. Int J Hydrogen Energy 1988;13(9):539-46.
[6] Ohya H, Yatabe M, Aihara M, Negishi Y, Takeuchi T. Feasibility of hydrogen production above 2500 K by direct thermal decomposition reaction in membrane reactor using solar energy. Int J Hydrogen Energy 2002;27(4):369-76.
[7] Fan J, Ohya H, Suga T, Ohashi H, Yamashita K, Tsuchiya S, Aihara M, Takeuchi T, Negishi Y. High flux zirconia composite membrane for hydrogen separation at elevated temperature. J Membr Sci 2000;170(1):113-25.
[8] Pyle W R, Hayes M H, Spivak A L. Direct solar thermal hydrogen production from water using nozzle/skimmer and glow discharge, H-ion, Inc.
[9] Lundberg M. Model-calculations on some feasible 2-step water splitting processes. Int J Hydrogen Energy 1993;18(5):369-76.
[10] Steinfeld A, Kuhn P, Reller A, Palumbo R, Murray J, Tamaura Y. Solar-processed metals as clean energy carriers and water-splitters. Int J Hydrogen Energy 1998;23(9): 767-74.
[11] Steinfeld A. Solar hydrogen production via a two-step water-splitting thermochemical cycle based on Zn/ZnO redox reactions. Int J Hydrogen Energy 2002;27(6):611-9.
[12] Palumbo R, Lede J, Boutin O, Ricart E E, Steinfeld A, Moller S, Weidenka_A, Fletcher E A, Bielicki J. The production of Zn from ZnO in a high-temperature solar decomposition quench process—I. The scientific framework for the process. Chem Eng Sci 1998;53(14):2503-17.
[13] Moller S, Palumbo R. Solar thermal decomposition kinetics of ZnO in the temperature range 1950-2400 K. Chem Eng Sci 2001;56(15):4505-15.
[14] Bilgen E, Ducarroir M, Foex M, Sibieude F, Trombe F. Use of solar-energy for direct and 2-step water decomposition cycles. Int J Hydrogen Energy 1977;2(3):251-7.
[15] Berman A, Epstein M. The kinetics of hydrogen production in the oxidation of liquid zinc with water vapor. Int J Hydrogen Energy 2000;25(10):957-67.
[16] Steinfeld A, Sanders S, Palumbo R. Design aspects of solar thermochemical engineering—A case study: two-step water-splitting cycle using the Fe3O4/FeO redox system. Sol Energy 1999;65(1):43-53.
[17] Wieckert C, Steinfeld A. Solar thermal reduction of ZnO using CH₄:ZnO and C:ZnO molar ratios less than 1. J Sol Energy Eng-Trans ASME 2002;124(1):55-62.
[18] Lede J, Boutin O, Elorza-Ricart E, Ferrer M, Mollard F. Production of zinc from the reduction of ZnO in the presence of cellulose in a solar simulator. J Sol Energy Eng—Trans ASME 2001;123(2):102-8.
[19] Steinfeld A, Fletcher E A. Theoretical and experimental investigation of the carbothermic reduction of Fe2O3 using solar-energy. Energy 1991;16(7):1011-9.
[20] Steinfeld A, Brack M, Meier A, Weidenka_A, Wuillemin D. A solar chemical reactor for co-production of zinc and synthesis gas. Energy 1998;23(10):803-14.
[21] Steinfeld A, Frei A, Kuhn P, Wuillemin D. Solar thermal production of zinc and syngas via combined ZnO-reduction and CH4-reforming processes (vol. 20, p. 793, 1995). Int J Hydrogen Energy 1996;21(3):243.
[22] Steinfeld A, Larson C, Palumbo R, Foley M. Thermodynamic analysis of the co-production of zinc and synthesis gas using solar process heat. Energy 1996;21(3):205-22.
[23] Sturzenegger M, Nuesch P. Efficiency analysis for a manganese-oxide-based thermochemical cycle. Energy 1999;24(11):959-70.
[24] Shimizu S, Onuki K, Nakajima H. Bench-scale studies of the iodine sulfur process. In: Technical committee meeting on high temperature applications of nuclear energy. Oarai. Japan: International Atomic Energy Agency, 1992.
[25] Cappelen, H, Johansen K H, Motzfeldt K. Oxidation of silicon-carbide in oxygen and in water-vapor at 1500-degrees-C. Acta Chem Scand Ser A—Phys and Inorg Chem 1981;35(4):247-54.
[26] Nickel K G. Corrosion of non-oxide ceramics. Ceram Int 1997;23(2):127-33.
[27] Matovich E. High temperature chemical reaction processes utilizing fluid-wall reactors. United States: Thagard Technology Company; 1978.
[28] Dahl J K, Weimer A W, Krantz W B. Sensitivity analysis of the rapid decomposition of methane in an aerosol flow reactor. Int J Hydrogen Energy 2004;29(1):57-65.
[29] Dahl J, Weimer A, Lewandowski A, Bingham C, Bruetsch F, Steinfeld A. Dry reforming of methane using a solar-thermal aerosol flow reactor. Ind Eng Chem Res, 2004, 43(18), 5489-5494.
[30] Dahl J, Buechler K, Weimer A, Lewandowski A, Bingham C. Solar-thermal dissociation of methane in a fluid-wall aerosol flow reactor. Int J Hydrogen Energy, 2004, 29(7), 725-736.
[31] Dahl J K, Buechler K J, Finley R, Stanislaus T, Weimer A W, Lewandowski A, Bingham C, Smeets A, Schneider A, Rapid solar-thermal Dissociation of Natural Gas in an Aerosol Flow Reactor. Energy, 2004, 29(5-6), 715-725.
[32] Dahl J K, Tamburini J, Weimer A W, Lewandowski A, Pitts R, Bingham C. Solar-thermal processing of methane to produce hydrogen and syngas. Energy Fuels 2001;15(5):1227-32.
[33] Keuneke, M. et al., (2004), Chem. Engr. Sci, 59, 2695-2704
[34] Perkins, C. and Weimer, A. W., (Dec. 2004) “Likely near-term solar-thermal water splitting technologies”, Intl. J. Hydrogen Energy, 29(15) 1569-1647.
[35] Kojima, M. et al. Thermochemical Decomposition of H2) to H2 on Cation-Excess Ferrite, J. Physics and Chem. of Solids, 57(11), November 1996, 1757-1763.
[36] Evdou, A. et al., Redox Materials for Hydrogen Production from the Water Decomposition Reaction, 2^{nd} Workshop of CPERI (Chemical Process Engineering Research Institute), 2004, 87-90.

We claim:

1. A method for reducing metal oxide particles comprising the steps of:
a) providing a solar-thermal fluid-wall aerosol transport reactor comprising an at least partially transparent outer protection shell and an inner reaction shell having an inlet and an outlet, the reaction shell being partially porous and having a porous section located at the outlet end of the shell;
b) flowing a first gas stream comprising entrained metal oxide particles from the inlet to the outlet of the reaction shell;
c) flowing a second gas stream radially inward through the porous section of the reaction shell, thereby generating a fluid wall along the inside of the reaction shell; and
d) heating the metal oxide particles in the reactor at least in part with a source of concentrated sunlight through indirect solar thermal heating to a temperature at which the metal oxide particles undergo a reduction reaction, thereby producing a reduced metal oxide product which is a metal, a metal oxide of a lower valence state, or a combination thereof.

2. The method of claim 1, wherein the temperature at the outlet end of the reaction shell is greater than the dissociation temperature of the metal oxide particles.

3. The method of claim 1, wherein the ratio of the length of the porous section of the reaction shell to the total length of the reaction shell is between about 1:2 and about 2:1.

4. The method of claim 1, wherein the metal oxide particles are ZnO particles.

5. The method of claim 1, wherein the metal oxide particles are Mn₂O₃ particles.

6. The method of claim 1, wherein the metal oxide particles are mixed metal ferrite particles.

7. The method of claim 1, further comprising providing a cooling device comprising a cooling chamber having an inlet and an outlet wherein the inlet of the cooling chamber is connected to the outlet of the solar-thermal reactor reaction shell and cooling the reduced metal oxide product by discharging the reduced metal oxide product into the cooling device.

8. The method of claim 7, wherein the temperature at the cooling chamber wall is less than the melting temperature of the reduced metal oxide product.

9. The method of claim 7, wherein the cooling chamber further comprises a fluid wall.

10. A method for reducing metal oxide particles comprising the steps of:
a) providing a solar reactor system comprising a solar-thermal aerosol transport reactor and a cooling device, the solar-thermal reactor comprising an at least partially transparent outer protection shell and a reaction shell having an inlet and an outlet and the cooling device comprising a cooling chamber having an inlet and an outlet and comprising an inner wall comprising a porous section, the inlet of the cooling chamber being connected to the outlet of the solar-thermal reactor reaction shell;
b) flowing a first gas stream comprising entrained metal oxide particles from the inlet to the outlet of the reaction shell;
c) flowing a second gas stream radially inward through the porous section of the inner cooling chamber wall, thereby generating a fluid wall along the inside of the inner cooling chamber wall; and
d) heating the metal oxide particles in the reactor at least in part with a source of concentrated sunlight through indirect solar thermal heating to a temperature at which the metal oxide particles undergo a reduction reaction thereby producing a reduced metal oxide product which is a metal, a metal oxide of a lower valence state, or a combination thereof; and
e) cooling the reduced metal oxide product by discharging reduced metal oxide product into the cooling device.

11. The method of claim 10, wherein the metal oxide particles are ZnO.

12. The method of claim 10, wherein the metal oxide particles are Mn₂O₃.

13. The method of claim 10, wherein the metal oxide particles are mixed metal ferrite particles.

14. The method of claim 10, wherein the temperature at the outlet of the reaction shell is greater than the dissociation temperature of the metal oxide particles.

15. A method for producing hydrogen comprising the steps of:
a) reducing metal oxide particles by the method of claim 1, thereby producing a reduced metal oxide product; and
reacting the reduced metal oxide product with water vapor to form hydrogen.

16. The method of claim 15 wherein the metal oxide particles are ZnO and the reduced metal oxide product is Zn.

17. The method of claim 15, wherein the metal oxide particles are mixed metal ferrite particles.

18. A method for producing hydrogen comprising the steps of:
a) reducing metal oxide particles by the method of claim 10, thereby producing a reduced metal oxide product; and
b) reacting the reduced metal oxide product with water vapor to form hydrogen.

19. The method of claim 18 wherein the metal oxide particles are ZnO and the reduced metal oxide product is Zn.

20. The method of claim 18, wherein the metal oxide particles are mixed metal ferrite particles.

21. A method for producing hydrogen comprising the steps of:
a) reducing particles of a first metal oxide by the method of claim 1, thereby producing a second metal oxide of a lower valence state;
b) reacting the second metal oxide of a lower valence state with sodium hydroxide to produce hydrogen and a sodium metal oxide; and
c) reacting the sodium metal oxide with water vapor to produce the first metal oxide and sodium hydroxide.

22. The method of claim 21, wherein the first metal oxide is Mn₂O₃ and the second metal oxide of a lower valence state is MnO.

23. A method for producing hydrogen comprising the steps of:
a) reducing particles of a first metal oxide by the method of claim 10, thereby producing a second metal oxide of a lower valence state;
b) reacting the second metal oxide of a lower valence state with sodium hydroxide to produce hydrogen and a sodium metal oxide; and
c) reacting the sodium metal oxide with water vapor to produce the first metal oxide and sodium hydroxide.

24. The method of claim 23, wherein the first metal oxide is Mn₂O₃ and the second metal oxide of a lower valence state is MnO.

25. A solar-thermal reactor system comprising
a) a solar-thermal aerosol transport reactor comprising a partially porous first inner shell having an inlet and an outlet and a porous section located at the outlet end of the first inner shell, a second inner shell substantially enclosing the first inner shell, an at least partially transparent outer shell substantially enclosing the second inner shell, a first gas plenum located substantially between the first and second inner shell, the first gas plenum having an inlet and an outlet, and a second gas plenum located substantially between the second inner shell and the outer shell, the second gas plenum having an inlet and an outlet; and
b) a cooling device comprising a cooling chamber having an inlet and an outlet, the inlet of the cooling chamber being connected to the outlet of the solar thermal reactor first inner shell and the inner diameter of the cooling chamber being greater than the inner diameter of the first inner shell.

26. The reaction system of claim 25, wherein the cooling chamber further comprises a inner first wall comprising a porous section, a second wall substantially enclosing the first wall and a third gas plenum located substantially between the first and second wall, the third gas plenum having an inlet and an outlet.

27. A solar-thermal reactor system comprising:
a) a solar-thermal aerosol transport reactor comprising a nonporous first inner shell having an inlet and an outlet, a second inner shell substantially enclosing the first inner shell, an at least partially transparent outer shell substantially enclosing the second inner shell, a first gas plenum located substantially between the first and second inner shell, the first gas plenum having an inlet and an outlet, and a second gas plenum located substantially between the second inner shell and the outer shell, the second gas plenum having an inlet and an outlet; and
b) a cooling device comprising a cooling chamber having an inlet and an outlet and comprising an inner first wall comprising a porous section and a second wall substantially enclosing the first wall and a third gas plenum located substantially between the first and second wall, the third gas plenum having an inlet and an outlet, the inlet of the cooling device being connected to the outlet of the first inner shell of the solar-thermal reactor.
